(19) United States
(12) Patent Application Publication
(10) Pub. No.: US 2022/0403100 A1
(43) Pub. Date: Dec. 22, 2022

(54) ELECTROCHROMIC POLYMER AND ELECTROCHROMIC DEVICES CONTAINING THE SAME

(71) Applicant: AMBILIGHT INC., Milpitas, CA (US)

(72) Inventors: Wenting WU, West Lafayette, IN (US); Jianguo MEI, West Lafayette, IN (US)

(21) Appl. No.: 17/826,734

(22) Filed: May 27, 2022

Related U.S. Application Data
(60) Provisional application No. 63/195,417, filed on Jun. 1, 2021.

(51) Int. Cl. C08G 61/12; G02F 1/1516

(52) U.S. Cl. CPC C08G 61/126; G02F 1/15165; C08G 2261/3247; C08G 2261/54

(57) ABSTRACT

A method for forming an electrochromic polymer block includes: forming each of reaction units by reacting two or more electron-donor groups, wherein each of the reaction units includes (i) a first backbone formed by the two or more electron-donor groups and (ii) at least one reactive functional group connected to each end of the first backbone; and forming the electrochromic polymer block by reacting at least two of the reaction units with acid-catalyzed cationic polymerization, wherein the electrochromic polymer block includes a second backbone formed by two or more of the first backbones.

### CROSS REFERENCE TO RELATED APPLICATIONS

This application claims benefit of and priority to U.S. Provisional Application No. 63/195,417, filed on Jun. 1, 2021, the content of which is incorporated herein in its entirety.

### TECHNICAL FIELD

The present disclosure is generally related to a method for forming an electrochromic polymer block by an acid-catalyzed cationic polymerization initiated by a reaction unit and a method for forming an electrochromic device.

### BACKGROUND

Electrochromic polymers (ECPs) can reversely change or adjust the color or optical transmittance of light. Various applications for electrochromic polymers can be found in different types of devices, such as e-paper, smart windows, and anti-glare rearview mirror. A lot of electrochromic polymers have been developed with different colors and structures. Conventionally, introducing tunable module blocks to the ECPs can endow various possible features to the ECPs, including enriched color library, improved optical contrast, higher stability, and better electrochromic performance.

### SUMMARY

The present invention is related to a method for forming an electrochromic polymer block by an acid-catalyzed cationic polymerization initiated by a reaction unit and a method for forming an electrochromic device.

In one aspect, a method for forming an electrochromic polymer block includes: forming each of reaction units by reacting two or more electron-donor groups, wherein each of the reaction units includes (i) a first backbone formed by the two or more electron-donor groups and (ii) at least one reactive functional group connected to each end of the first backbone; and forming the electrochromic polymer block by reacting at least two of the reaction units with acid-catalyzed cationic polymerization, wherein the electrochromic polymer block includes a second backbone formed by two or more of the first backbones.

In some embodiments, the two or more electron-donor groups are the same. In some embodiments, at least two of the two or more electron-donor groups are different.

In some embodiments, at least one of the reaction units is formed by reacting the two or more electron-donor groups with an electron-acceptor group such that the electron-acceptor group is sandwiched by two of the two or more electron-donor groups in the first backbone.

In some embodiments, at least one of the reaction units is formed by reacting three different electron-donor groups such that the first backbone is formed by the three different electron-donor groups.

In some embodiments, the reactive functional groups comprise one of H, Br, Cl, or I. In some embodiments, the acid-catalyzed cationic polymerization comprises Lewis-acid catalyzed cationic polymerization or Brønsted-acid catalyzed cationic polymerization. In some embodiments, the two or more electron-donor groups comprise thiophene, EDOT, pyrrole, carbazole, triphenylamine, or benzos. In some embodiments, the electron-acceptor group comprises benzothiadiazole (BT), thiazole, pyridine, fluorinated benzene (FB), diketopyrrolopyrrole (DPP), isoindigo (ID), thieno[3,4-c]pyrrole-4,6-dione (TPD) and quinoxalineimide.

In another aspect, a method for forming an electrochromic polymer comprises reacting the disclosed electrochromic polymer block with at least one reaction unit by acid-catalyzed cationic polymerization.

In yet another aspect, a method for forming an electrochromic polymer comprises: forming each of reaction units by reacting two or more electron-donor groups, wherein each of the reaction units includes (i) a first backbone formed by the two or more electron-donor groups and (ii) at least one reactive functional group connected to each end of the first backbone; and forming the electrochromic polymer by reacting an electrochromic polymer block with at least one of the reaction units by acid-catalyzed cationic polymerization, wherein the electrochromic polymer block has at least one electron donor group end capped with at least one reactive functional group.

A method for forming an electrochromic device comprises: forming each of reaction units by reacting two or more electron-donor groups, wherein each of the reaction units includes (i) a first backbone formed by the two or more electron-donor groups and (ii) at least one reactive functional group connected to each end of the first backbone; forming the electrochromic polymer block by reacting at least two of the reaction units with acid-catalyzed cationic polymerization, wherein the electrochromic polymer block includes a second backbone formed by two or more of the first backbones; and incorporating the electrochromic polymer block into a cell coupled to two electrodes.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention are utilized, and the accompanying drawings below. For the purpose of illustrating the invention, the drawings show aspects of one or more embodiments of the invention. However, it should be understood that the present invention is not limited to the precise arrangements and instrumentalities shown in the drawings.

FIGS. 1A-1G are the schemes of forming example electrochromic polymer blocks. ACCP represents acid-catalyzed cationic polymerization. H/X represents the reactive functional group. Each example reaction unit comprises two H/X with one Hydrogen and one X. Each of X is independently selected from a group including, but not limited to, Br, Cl, I. [symbol] is a polymer block with at least one oligomer or one homopolymer or one copolymer synthesized by any reactions other than acid-catalyzed cationic polymerization. n and m are integers greater than 0.

FIG. 2 is a cyclic voltammogram of the example electrochromic polymer (ProDOT-Ph-ProDOT)ₙ, according to one exemplary embodiment.

FIG. 3 is the absorbance spectra at colored state (dash line) and bleach state (solid line) of the example electrochromic polymer (ProDOT-Ph-ProDOT)ₙ, according to one exemplary embodiment.

FIG. 4 illustrates switching kinetic of an example electrochromic polymer (ProDOT-Ph-ProDOT)ₙ thin film, according to one exemplary embodiment.

### DETAILED DESCRIPTION OF EMBODIMENTS

In the following description, certain specific details are set forth in order to provide a thorough understanding of various embodiments of the invention. However, one skilled in the art will understand that the invention may be practiced without these details. Moreover, while various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way.

Unless the context requires otherwise, throughout the present specification and claims, the word “comprise” and variations thereof, such as “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it was individually recited herein. Additionally, the singular forms “a” “an”, and “the” include plural referents unless the context clearly dictates otherwise.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment, but maybe in some instances. Furthermore, the particular features, structures, or characteristics may be combined in any suitable manner in one or more embodiments.

This invention is related to a method for forming an electrochromic polymer block by an acid-catalyzed cationic polymerization initiated by a reaction unit and a method for forming an electrochromic device.

The disclosed electrochromic polymer comprises a backbone and at least one polymer block. The polymer block is synthesized by an acid-catalyzed cationic polymerization, and the acid-catalyzed cationic polymerization is initiated by a reaction unit. The reaction unit comprises at least a first electron donor group and a second electron donor group. The reaction unit further comprises reactive functional groups with at least one Hydrogen and at least one halogen on the backbone, so that the reaction between Hydrogen and halogen allows the formation of the conjugated backbone. The reactive functional group comprises H, Br, Cl, I. The acid-catalyzed cationic polymerization comprises Lewis-acid catalyzed cationic polymerization or Brønsted-acid catalyzed cationic polymerization.

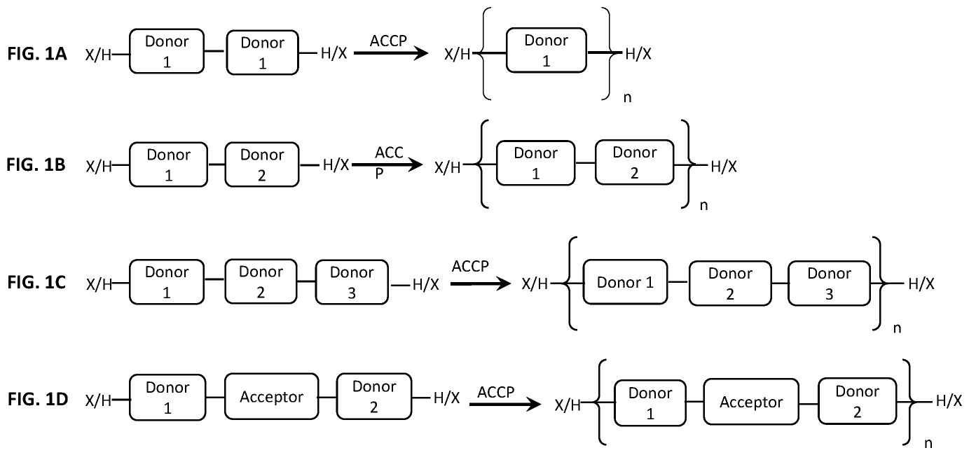

The disclosed electrochromic polymer comprises at least one polymer block synthesized by an acid-catalyzed cationic polymerization. As shown in FIG. 1, in some embodiments, the entire disclosed polymer is synthesized by an acid-catalyzed cationic polymerization. The disclosed polymer may be homopolymer or copolymer or block copolymer. In some embodiments, besides the blocks synthesized by an acid-catalyzed cationic polymerization, the disclosed electrochromic polymer further comprises at least one oligomer or one homopolymer or one copolymer synthesized by any reactions other than acid-catalyzed cationic polymerization, for example, random polymerization. The disclosed electrochromic polymer may only comprise one block synthesized by an acid-catalyzed cationic polymerization or at least two blocks synthesized by an acid-catalyzed cationic polymerization with other blocks synthesized by any other reactions.

Conventional acid-catalyzed cationic polymerization is only initiated by one electron donor group. In this disclosure, polymerization reaction is initiated with larger reaction units with more electron donor groups (more electron-rich), leading to a greater polymerization yield and larger and more uniform (lower PDI) polymer products. The reaction unit to initiate the acid-catalyzed cationic polymerization comprises at least a first electron donor group (Donor 1) and a second electron donor group (Donor 2). The electron donor groups can be the same (FIG. 1A) or different (FIG. 1B). In some embodiments, the reaction unit to initiate the acid-catalyzed cationic polymerization may be dimer consisting of two electron donor groups. Depending on whether the two electron donor groups in the reaction unit are the same or different, the disclosed polymer may be a homopolymer or may be a copolymer. In some embodiments, the reaction unit may have more than two electron donor groups, for example, trimer, tetramer, pentamer, etc. When the reaction unit comprises more than two electron donor groups, in some embodiments, the reaction unit comprises at least one electron acceptor group between the first and the second electron donor groups. The electron donor groups may be the same or different.

The introduction of electron acceptor groups into the electrochromic polymer can lower the bandgap, enhance the electrochromic polymer's color library, and improve optical contrast and polymer stability.

The electron donor group, for example, comprises thiophene, EDOT, pyrrole, carbazole, triphenylamine, and benzos. The electron acceptor group, for example, comprises benzothiadiazole (BT), thiazole, pyridine, fluorinated benzene (FB), diketopyrrolopyrrole (DPP), isoindigo (ID), thieno[3,4-c]pyrrole-4,6-dione (TPD) and quinoxalineimide.

As shown in FIG. 1B, in some embodiments, the reaction unit is a dimer with two electron donor groups. The reaction unit is [-D₁-D₂-] end-capped with at least one Hydrogen and at least one halogen reactive functional group, wherein D₁ and D₂ (Donor 1 and Donor 2) are independently selected from the group comprising:

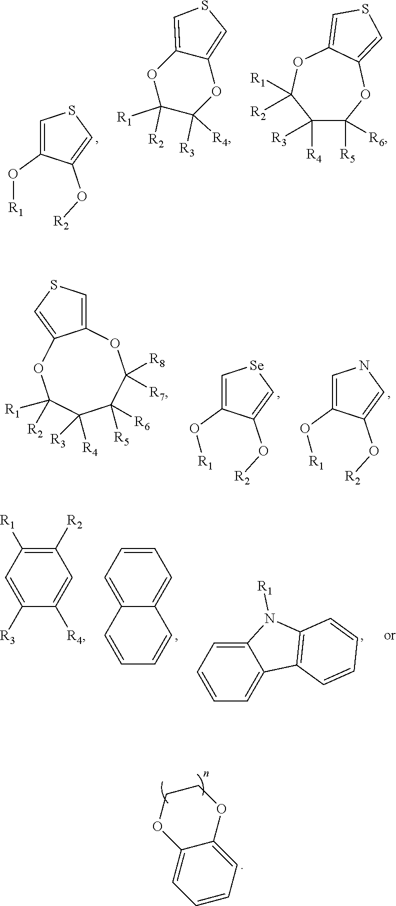

Each of R₁, R₂, R₃, R₄, R₅, R₆, R₇, and R₈ is independently selected from a group including, but not limited to, hydrogen, C₁-C₃₀ alkyl, C₂-C₃₀ alkenyl, C₂-C₃₀ alkynyl, C₂-C₃₀ alkylcarbonyl, C₁-C₃₀ alkoxy, C₃-C₃₀ alkoxyalkyl, C₂-C₃₀ alkoxycarbonyl, C₄-C₃₀ alkoxycarbonylalkyl, C₁-C₃₀ aminylcarbonyl, C₁-C₃₀ aminylalkyl, C₁-C₃₀ alkylaminyl, C₁-C₃₀ alkylsulfonyl, C₃-C₃₀ alkylsulfonylalkyl, C₆-C₁₈ aryl, C₃-C₁₅ cycloalkyl, C₃-C₃₀ cycloalkylaminyl, C₅-C₃₀cycloalkylalkylaminyl, C₅-C₃₀ cycloalkylalkyl, C₅-C₃₀ cycloalkylalkyloxy, C₁-C₁₂ heterocyclyl, C₁-C₁₂ heterocyclyloxy, C₃-C₃₀ heterocyclylalkyloxy, C₁-C₃₀ heterocyclylalkyloxy, C₁-C₃₀ heterocyclylaminyl, C₅-C₃₀ heterocyclylalkylaminyl, C₂-C₁₂ heterocyclylcarbonyl, C₃-C₃₀ heterocyclylalkyl, C₁-C₁₃ heteroaryl, or C₃-C₃₀ heteroarylalkyl. n is an integer greater than 0. D₁ and D₂, may be the same or different.

In some embodiments, the reaction unit comprises:

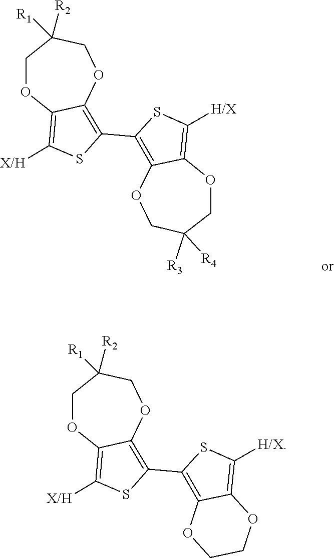

Each of R₁, R₂, R₃, and R₄ is independently selected from a group including, but not limited to, hydrogen, C₁-C₃₀ alkyl, C₂-C₃₀ alkenyl, C₂-C₃₀ alkynyl, C₂-C₃₀ alkylcarbonyl, C₁-C₃₀ alkoxy, C₃-C₃₀ alkoxyalkyl, C₂-C₃₀ alkoxycarbonyl, C₄-C₃₀ alkoxycarbonylalkyl, C₁-C₃₀ aminylcarbonyl, C₄-C₃₀ aminylalkyl, C₁-C₃₀ alkylaminyl, C₁-C₃₀ alkylsulfonyl, C₃-C₃₀ alkylsulfonylalkyl, C₆-C₁₈ aryl, C₃-C₁₅ cycloalkyl, C₃-C₃₀ cycloalkylaminyl, C₅-C₃₀ cycloalkylalkylaminyl, C₅-C₃₀ cycloalkylalkyl, C₅-C₃₀ cycloalkylalkyloxy, C₁-C₁₂ heterocyclyl, C₁-C₁₂ heterocyclyloxy, C₃-C₃₀ heterocyclylalkyloxy, C₁-C₃₀ heterocyclylalkyloxy, C₁-C₃₀ heterocyclylaminyl, C₅-C₃₀ heterocyclylalkylaminyl, C₂-C₁₂ heterocyclylcarbonyl, C₃-C₃₀ heterocyclylalkyl, C₁-C₁₃ heteroaryl, or C₃-C₃₀ heteroarylalkyl.

H/X represents the reactive functional group. Each example reaction unit comprises two H/X with one Hydrogen and one X. Each of X is independently selected from a group including, but not limited to, Br, Cl, and I.

As shown in FIG. 1C, in some embodiments, the reaction unit is a trimer with three electron donor groups (Donor 1, Donor 2, Donor3). The reaction unit is [-D₁-D₂-D₃-] end-capped with at least one Hydrogen and at least one halogen reactive functional group, wherein D₁, D₂, and D₃ are independently selected from the group comprising:

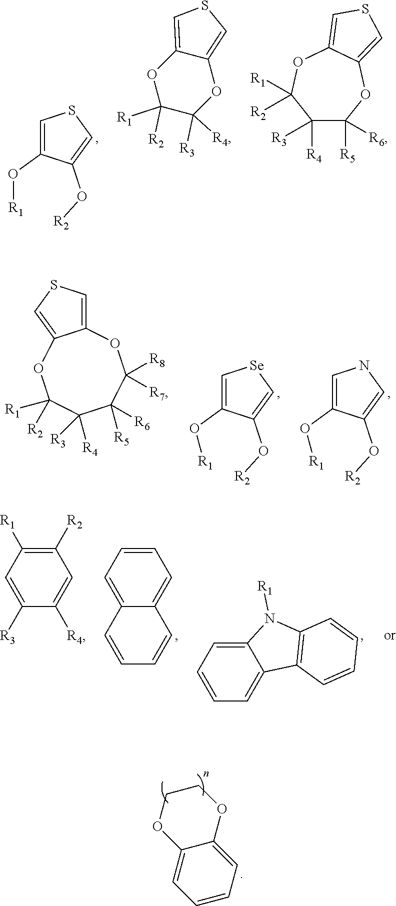

Each of R₁, R₂, R₃, R₄, R₅, R₆, R₇, and R₈ is independently selected from a group including, but not limited to, hydrogen, C₁-C₃₀ alkyl, C₂-C₃₀ alkenyl, C₂-C₃₀ alkynyl, C₂-C₃₀ alkylcarbonyl, C₁-C₃₀ alkoxy, C₃-C₃₀ alkoxyalkyl, C₂-C₃₀ alkoxycarbonyl, C₄-C₃₀ alkoxycarbonylalkyl, C₁-C₃₀ aminylcarbonyl, C₄-C₃₀ aminylalkyl, C₁-C₃₀ alkylaminyl, C₁-C₃₀ alkylsulfonyl, C₃-C₃₀ alkylsulfonylalkyl, C₆-C₁₈ aryl, C₃-C₁₅ cycloalkyl, C₃-C₃₀ cycloalkylaminyl, C₅-C₃₀ cycloalkylalkylaminyl, C₅-C₃₀ cycloalkylalkyl, C₅-C₃₀ cycloalkylalkyloxy, C₁-C₁₂ heterocyclyl, C₁-C₁₂ heterocyclyloxy, C₃-C₃₀ heterocyclylalkyloxy, C₁-C₃₀ heterocyclylalkyloxy, C₁-C₃₀ heterocyclylaminyl, C₅-C₃₀ heterocyclylalkylaminyl, C₂-C₁₂ heterocyclylcarbonyl, C₃-C₃₀ heterocyclylalkyl, C₁-C₁₃ heteroaryl, or C₃-C₃₀ heteroarylalkyl. n is an integer greater than 0. D₁, D₂, and D₃ may be the same or different.

In some embodiments, the reaction unit comprises:

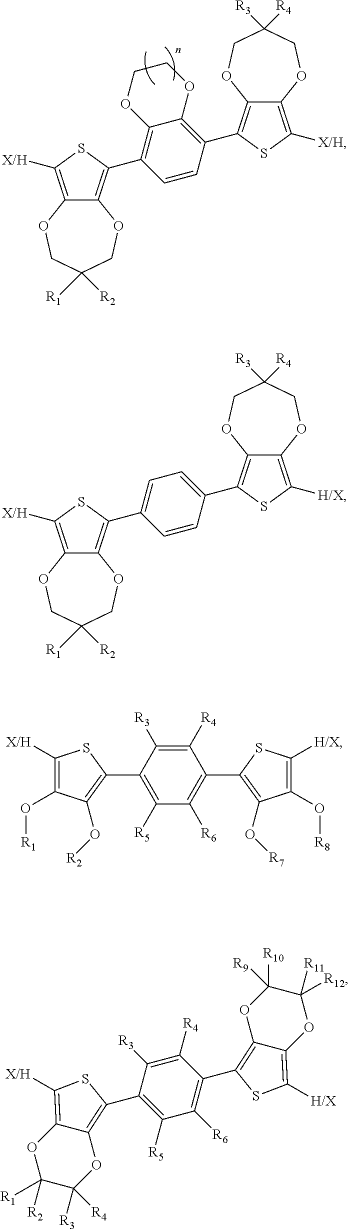

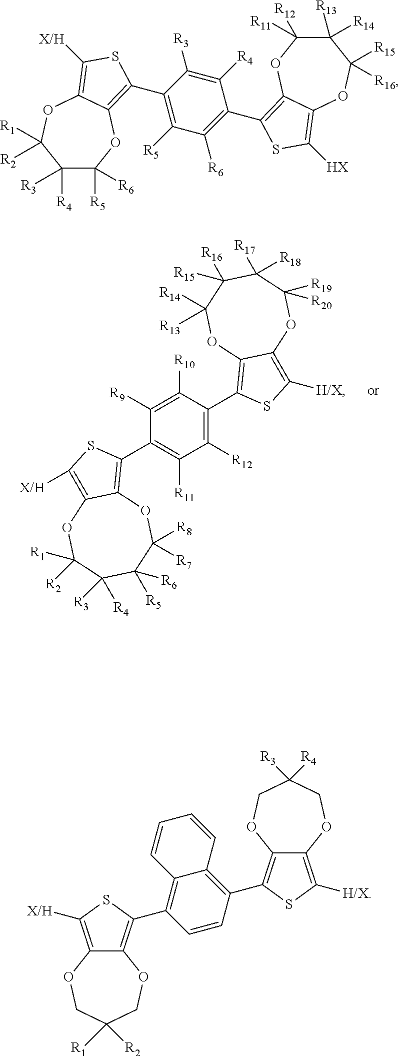

Each of R₁, R₂, R₃, R₄, R₅, R₆, R₇, R₈, R₉, R₁₀, R₁₁, R₁₂, R₁₃, R₁₄, R₁₅, R₁₆, R₁₇, R₁₈, R₁₉, and R₂₀ is independently selected from a group including, but not limited to, hydrogen, C₁-C₃₀ alkyl, C₂-C₃₀ alkenyl, C₂-C₃₀ alkynyl, C₂-C₃₀ alkylcarbonyl, C₁-C₃₀ alkoxy, C₃-C₃₀ alkoxyalkyl, C₂-C₃₀ alkoxycarbonyl, C₁-C₃₀ alkoxycarbonylalkyl, C₁-C₃₀ aminylcarbonyl, C₄-C₃₀ aminylalkyl, C₁-C₃₀ alkylaminyl, C₁-C₃₀ alkylsulfonyl, C₃-C₃₀ alkylsulfonylalkyl, C₆-C₁₈ aryl, C₃-C₁₅ cycloalkyl, C₃-C₃₀ cycloalkylaminyl, C₅-C₃₀ cycloalkylalkylaminyl, C₅-C₃₀ cycloalkylalkyl, C₅-C₃₀ cycloalkylalkyloxy, C₁-C₁₂ heterocyclyl, C₁-C₁₂ heterocyclyloxy, C₃-C₃₀ heterocyclylalkyloxy, C₁-C₃₀ heterocyclylalkyloxy, C₁-C₃₀ heterocyclylaminyl, C₅-C₃₀ heterocyclylalkylaminyl, C₂-C₁₂ heterocyclylcarbonyl, C₃-C₃₀ heterocyclylalkyl, C₁-C₁₃ heteroaryl, or C₃-C₃₀ heteroarylalkyl.

H/X represents the reactive functional group. Each example reaction unit comprises two H/X with one Hydrogen and one X. Each of X is independently selected from a group including, but not limited to, Br, Cl, and I. n is an integer greater than 0.

As shown in FIG. 1D, in some embodiments, the reaction unit comprises one electron acceptor group (Acceptor) between two electron donor groups (Donor 1 and Donor 2) with a formula of [-D₁-A-D₂-] end-capped with at least one Hydrogen and at least one halogen reactive group, wherein D₁ and D₂ are electron donor units that are independently selected from the group comprising:

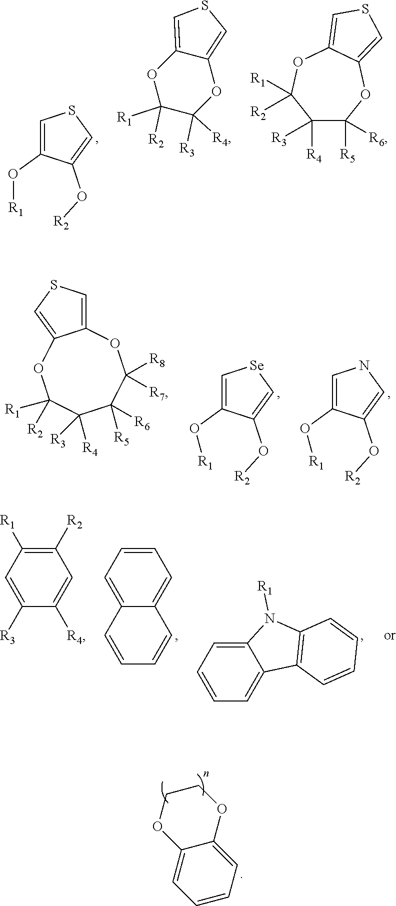

Each of R₁, R₂, R₃, R₄, R₅, R₆, R₇, and R₈ is independently selected from a group including, but not limited to, hydrogen, C₁-C₃₀ alkyl, C₂-C₃₀ alkenyl, C₂-C₃₀ alkynyl, C₂-C₃₀ alkylcarbonyl, C₁-C₃₀ alkoxy, C₃-C₃₀ alkoxyalkyl, C₂-C₃₀ alkoxycarbonyl, C₄-C₃₀ alkoxycarbonylalkyl, C₁-C₃₀ aminylcarbonyl, C₁-C₃₀ aminylalkyl, C₁-C₃₀ alkylaminyl, C₁-C₃₀ alkylsulfonyl, C₃-C₃₀ alkylsulfonylalkyl, C₆-C₁₈ aryl, C₃-C₁₅ is cycloalkyl, C₃-C₃₀ cycloalkylaminyl, C₅-C₃₀ cycloalkylalkylaminyl, C₅-C₃₀ cycloalkylalkyl, C₅-C₃₀ cycloalkylalkyloxy, C₁-C₁₂ heterocyclyl, C₁-C₁₂ heterocyclyloxy, C₃-C₃₀ heterocyclylalkyloxy, C₁-C₃₀ heterocyclylalkyloxy, C₁-C₃₀ heterocyclylaminyl, C₅-C₃₀ heterocyclylalkylaminyl, C₂-C₁₂ heterocyclylcarbonyl, C₃-C₃₀ heterocyclylalkyl, C₁-C₁₃ heteroaryl, or C₃-C₃₀ heteroarylalkyl. D₁ and D₂ may be the same or different. n is an integer greater than 0.

A is an electron acceptor unit selected from the group comprising:

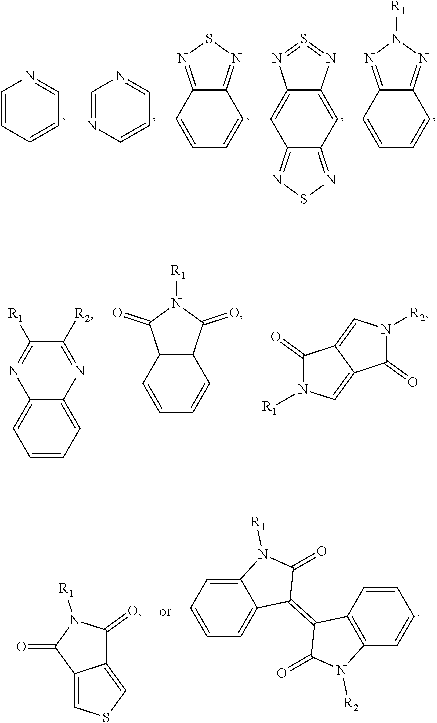

Each of R₁ and R₂ is independently selected from a group including, but not limited to, hydrogen, halogen, C₁-C₃₀ alkyl, C₂-C₃₀ alkenyl, C₂-C₃₀ alkynyl, C₂-C₃₀ alkylcarbonyl, C₁-C₃₀ alkoxy, C₃-C₃₀ alkoxyalkyl, C₂-C₃₀ alkoxycarbonyl, C₄-C₃₀ alkoxycarbonylalkyl, C₁-C₃₀ aminylcarbonyl, C₁-C₃₀ aminylalkyl, C₁-C₃₀ alkylaminyl, C₁-C₃₀ alkylsulfonyl, C₃-C₃₀ alkylsulfonylalkyl, C₆-C₁₈ aryl, C₃-C₁₅ cycloalkyl, C₃-C₃₀ cycloalkylaminyl, C₅-C₃₀ cycloalkylalkylaminyl, C₅-C₃₀cycloalkylalkyl, C₅-C₃₀ cycloalkylalkyloxy, C₁-C₁₂ heterocyclyl, C₁-C₁₂ heterocyclyloxy, C₃-C₃₀ heterocyclylalkyloxy, C₁-C₃₀ heterocyclylalkyloxy, C₁-C₃₀ heterocyclylaminyl, C₅-C₃₀ heterocyclylalkylaminyl, C₂-C₁₂ heterocyclylcarbonyl, C₃-C₃₀ heterocyclylalkyl, C₁-C₁₃ heteroaryl, or C₃-C₃₀ heteroarylalkyl.

In some embodiments, the reaction unit comprises:

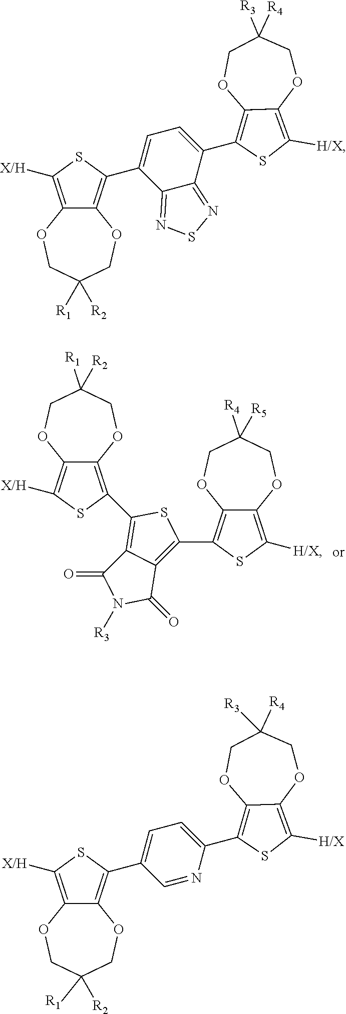

Each of R₁, R₂, R₃, R₄ and R₅ is independently selected from a group including, but not limited to, hydrogen, C₁-C₃₀ alkyl, C₂-C₃₀ alkenyl, C₂-C₃₀ alkynyl, C₂-C₃₀ alkylcarbonyl, C₁-C₃₀ alkoxy, C₃-C₃₀ alkoxyalkyl, C₂-C₃₀ alkoxycarbonyl, C₄-C₃₀ alkoxycarbonylalkyl, C₁-C₃₀ aminylcarbonyl, C₁-C₃₀ aminylalkyl, C₁-C₃₀ alkylaminyl, C₁-C₃₀ alkylsulfonyl, C₃-C₃₀ alkylsulfonylalkyl, C₆-C₁₈ aryl, C₃-C₁₅ cycloalkyl, C₃-C₃₀ cycloalkylaminyl, C₅-C₃₀ cycloalkylalkylaminyl, C₅-C₃₀ cycloalkylalkyl, C₅-C₃₀ cycloalkylalkyloxy, C₁-C₁₂ heterocyclyl, C₁-C₁₂ heterocyclyloxy, C₃-C₃₀ heterocyclylalkyloxy, C₁-C₃₀ heterocyclylalkyloxy, C₁-C₃₀ heterocyclylaminyl, C₅-C₃₀ heterocyclylalkylaminyl, C₂-C₁₂ heterocyclylcarbonyl, C₃-C₃₀ heterocyclylalkyl, C₁-C₁₃ heteroaryl, or C₃-C₃₀ heteroarylalkyl.

H/X represents the reactive functional group. Each example reaction unit comprises two H/X with one Hydrogen and one X. Each of X is independently selected from a group including, but not limited to, Br, Cl, and I.

In some illustrative embodiments, the reaction unit is a pentamer with the following formula:

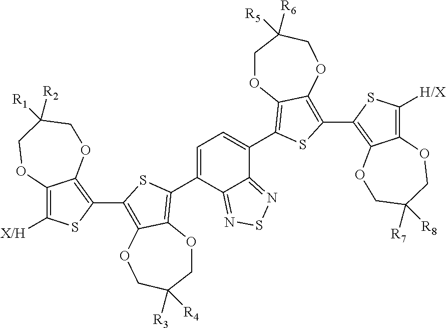

Each of R₁, R₂, R₃, R₄, R₅, R₆, R₇, and R₈ is independently selected from a group including, but not limited to, hydrogen, C₁-C₃₀ alkyl, C₂-C₃₀ alkenyl, C₂-C₃₀ alkynyl, C₂-C₃₀ alkylcarbonyl, C₁-C₃₀ alkoxy, C₃-C₃₀ alkoxyalkyl, C₂-C₃₀ alkoxycarbonyl, C₄-C₃₀ alkoxycarbonylalkyl, C₁-C₃₀ aminylcarbonyl, C₄-C₃₀ aminylalkyl, C₁-C₃₀ alkylaminyl, C₁-C₃₀ alkylsulfonyl, C₃-C₃₀ alkylsulfonylalkyl, C₆-C₁₈ aryl, C₃-C₁₅ cycloalkyl, C₃-C₃₀ cycloalkylaminyl, C₅-C₃₀ cycloalkylalkylaminyl, C₅-C₃₀ cycloalkylalkyl, C₅-C₃₀ cycloalkylalkyloxy, C₁-C₁₂ heterocyclyl, C₁-C₁₂ heterocyclyloxy, C₃-C₃₀ heterocyclylalkyloxy, C₁-C₃₀ heterocyclylalkyloxy, C₁-C₃₀ heterocyclylaminyl, C₅-C₃₀ heterocyclylalkylaminyl, C₂-C₁₂ heterocyclylcarbonyl, C₃-C₃₀ heterocyclylalkyl, C₁-C₁₃ heteroaryl, or C₃-C₃₀ heteroarylalkyl.

H/X represents the reactive functional group. Each example reaction unit comprises two H/X with one Hydrogen and one X. Each of X is independently selected from a group including, but not limited to, Br, Cl, and I.

In some embodiments, the disclosed electrochromic polymer blocks (e.g. the ones from FIGS. 1A, 1B, 1C and 1D) can further react with another reactive unit (may be dimer, trimer, tetramer, pentamer, et.) by acid-catalyzed cationic polymerization to form a block copolymer (for example, the ones illustrated in FIGS. 1E and 1F). In some embodiments, a polymer block synthesized by any reactions other than acid-catalyzed cationic polymerization, with at least one donor group at the end capped with at least one Hydrogen or halogen reactive functional group, can further react with one reactive unit (may be dimer, trimer, tetramer, pentamer, et.) by acid-catalyzed cationic polymerization to form a block copolymer. For example, FIG. 1G illustrates forming a polymer block by reacting the polymer block of FIG. 1D with a polymer block [symbol] with at least one oligomer or one homopolymer or one copolymer synthesized by any reactions other than acid-catalyzed cationic polymerization, with one donor group at the end capped with one Hydrogen or halogen reactive functional group.

### Embodiment 1: The Reaction Unit Comprises ProDOT-ProDOT-Cl

In some embodiments, the reaction unit comprises a dimer with two same electron donor groups (ProDOT₂-Cl):

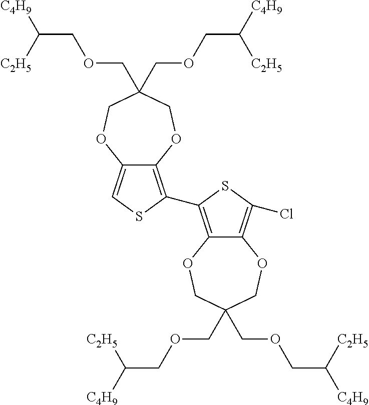

ProDOT₂-Cl, for example, may be prepared by adding Cl reactive functional group to dimer ProDOT₂. Scheme 1 illustrates a synthesis method according to one example embodiment.

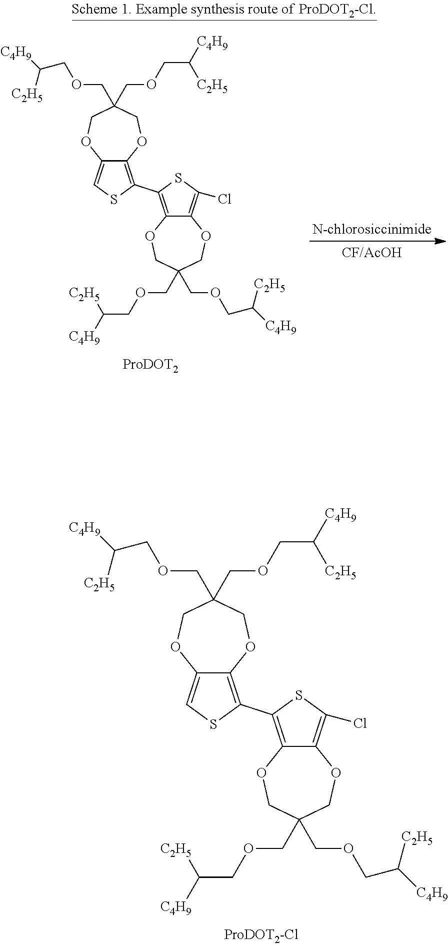

To a stirred solution of ProDOT₂ (3.8 mmol) in a mixture CHCl₃/AcOH (20 mL/20 mL) at 0° C., a solution of N-chlorosuccinimide (3.6 mmol) in 5 mL of chloroform is added dropwise, and the reaction mixture is stirred at room temperature overnight. To the reaction mixture, water (20 mL) is added and the mixture is washed with ethyl acetate (3×20 mL). The organic fraction is dried over anhydrous sulfate magnesium, the solvent is removed under reduced pressure, and the resulting material (˜69% yield) is purified by chromatography column on silica gel.

The polymer block is synthesized by an example acid-catalyzed cationic polymerization with ProDOT₂-Cl as the reaction unit as illustrated in scheme 2, according to one example embodiment.

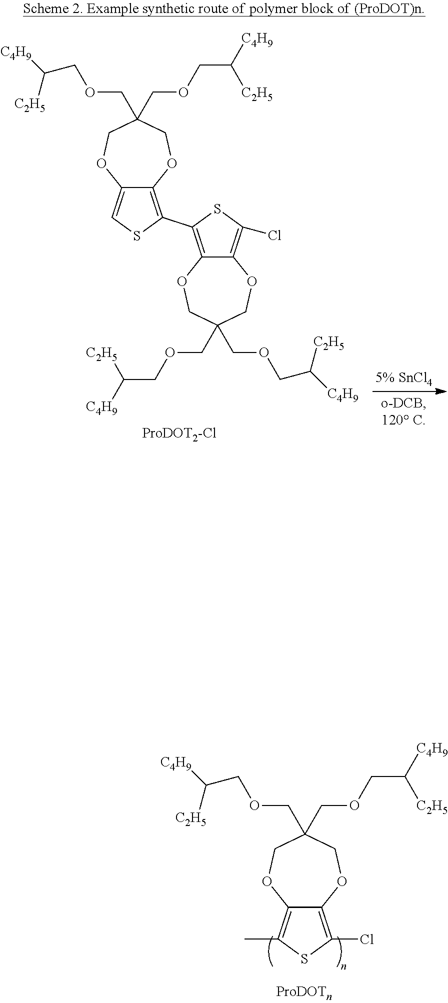

According to Scheme 2, to a solution of ProDOT₂-Cl (0.33 mmol) in anhydrous o-DCB (2 mL) at 120° C., SnCl₄ (5%, 8.6 mg, 3.8 μL, 0.03 mMol) in anhydrous o-DCB (0.2 mL) is added, and the resulting solution is stirred at 120° C. overnight. The disappearance of the monomer is checked by TLC, and if there are still reaction units left, another charge of SnCl₄ is added to the mixture and stirred at 120° C. for another 24 h. The reaction mixture is poured into MeOH (200 mL), and few drops (4-10) of hydrazine hydrate are added to neutralize/dedope the polymer. The mixture is stirred for 1-3 h to allow the precipitation of the product. The solid (˜81% yield) is filtered and washed with MeOH (200 mL) and hexanes (200 mL) and dried under vacuum.

### Embodiment 2: The Reaction Unit Comprises ProDOT-EDOT-Cl

In some embodiments, the reaction unit comprises a dimer with two different electron donor groups (ProDOT-EDOT-Cl):

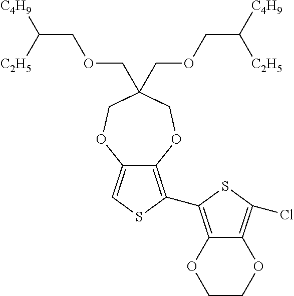

ProDOT-EDOT-Cl may be synthesized by the similar scheme as scheme 1 and then further adopts the similar scheme of acid-catalyzed cationic polymerization as scheme 2 to produce an electrochromic polymer block with a formula of

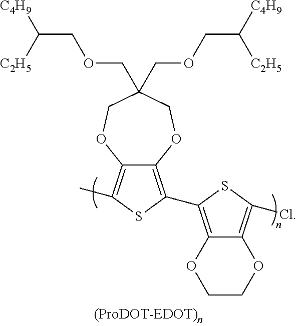

### Embodiment 3: The Reaction Unit Comprises ProDOT-pH-ProDOT-Cl

In some embodiments, the reaction unit comprises a trimer with three electron donor groups (ProDOT-Ph-ProDOT-Cl):

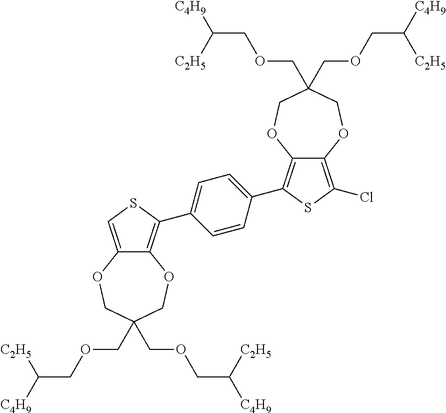

ProDOT-Ph-ProDOT-Cl, for example, may be prepared by a two-step synthesis method. Scheme 3 illustrates a two-step synthesis method according to one example embodiment.

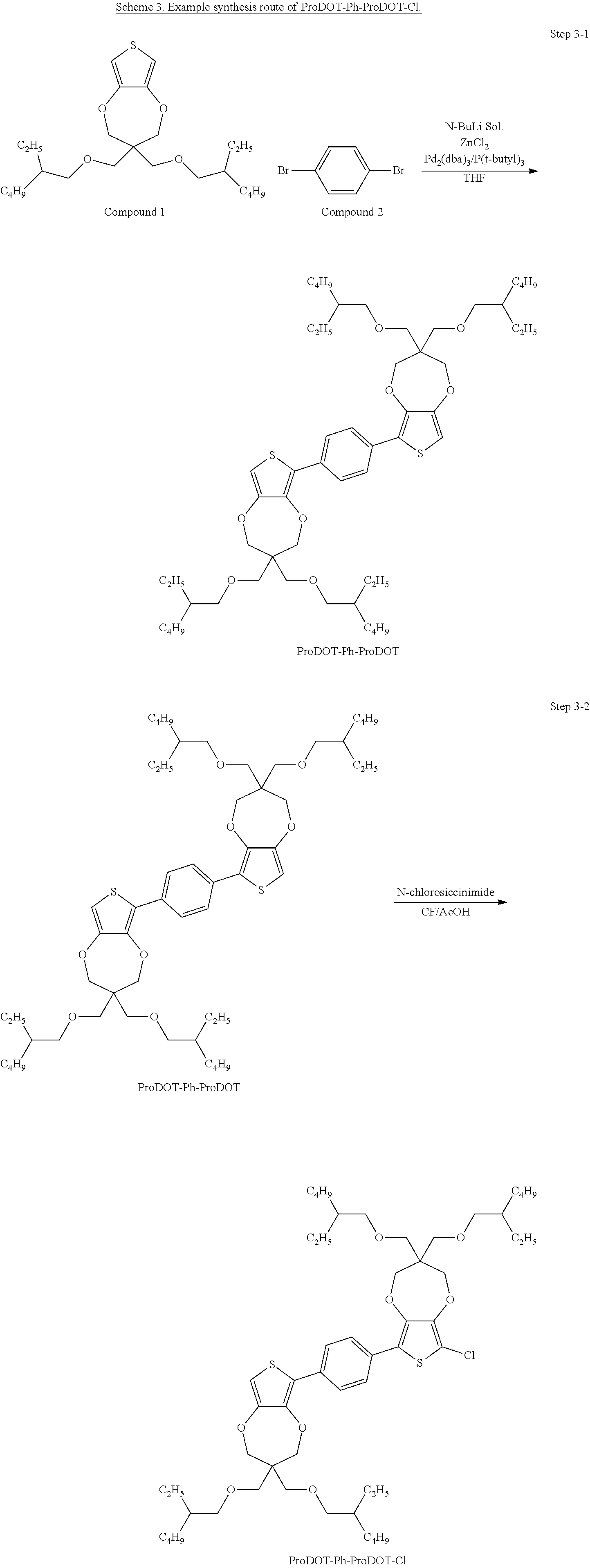

In example step 3-1, ProDOT-Ph-ProDOT is synthesized by first dissolving compound 1 (6.61 g, 15 mmol) in anhydrous THF (150 mL) in a 500 mL 3-neck round bottom flask equipped with a condenser under nitrogen. The solution is cooled to −78° C., and n-BuLi (16.2 mmol, 6.48 mL) is added dropwise via syringe, and the solution is stirred for 1 hour at −78° C. Zinc chloride in THF (2.81 g, 17.2 mmol) is added dropwise via syringe, and the solution is warmed to room temperature. Then, compound 2 (1.48 g, 5.00 mmol), Pd₂(dba)3 (0.18 g, 0.2 mmol), and P(t-Bu)₃ (0.081 g, 0.4 mmol) are dissolved in a mixture of anhydrous THF (100 mL) in a Schlenk flask. This purple solution is transferred via cannula to the solution containing the zinc chloride derivative of compound 1, and the mixture is heated at reflux for 36 hours. The light brown solution is cooled to room temperature and poured into deionized water (500 mL). The mixture is extracted with ethyl ether. The ether layer is washed with brine and dried over magnesium sulfate. After filtration through a Buchner funnel, the solvent is evaporated, and a light brown solid is collected. This solid is purified by column chromatography (hexanes:ether=20:1) to give 3.22 g yellow wax solid (˜63.4% yield).

In example step 3-2, to a stirred solution of ProDOT-Ph-ProDOT (3.8 mmol) in a mixture CHCl₃/AcOH (20 mL/20 mL) at 0° C., a solution of N-chlorosuccinimide (3.6 mmol) in 5 mL of chloroform is added dropwise, and the reaction mixture is stirred at room temperature overnight. To the reaction mixture, water (20 mL) is added and the mixture is washed with ethyl acetate (3×20 mL), the organic fraction is dried over anhydrous sulfate magnesium, the solvent is removed under reduced pressure, and the resulting material (˜69% yield) is purified by chromatography column on silica gel.

By the similar scheme of acid-catalyzed cationic polymerization as scheme 2, ProDOT-Ph-ProDOT-Cl may be used to produce an electrochromic polymer block with a formula of

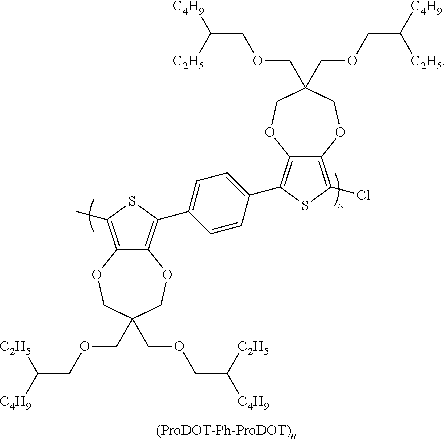

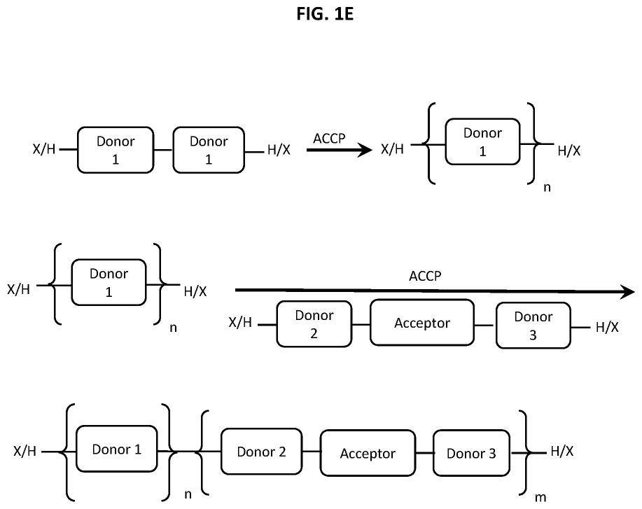

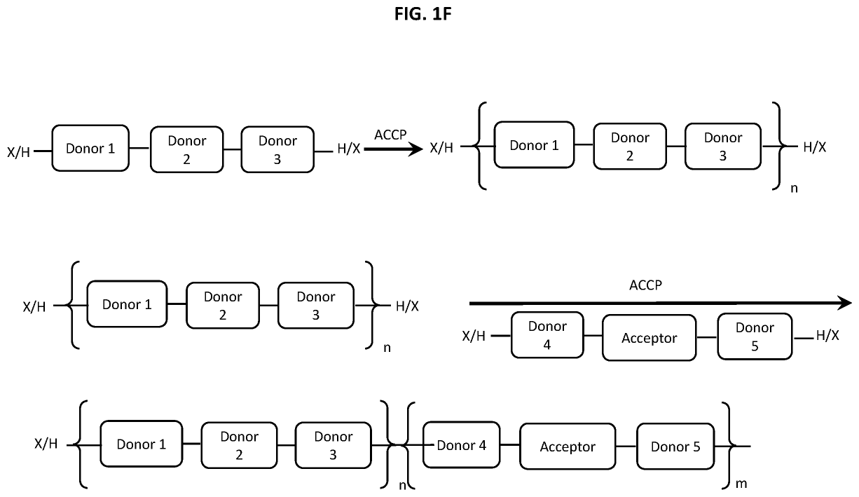

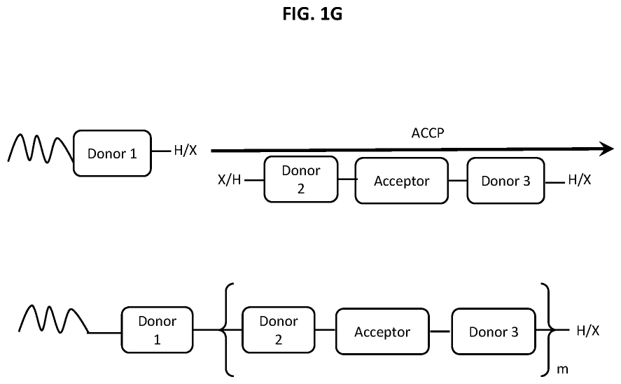

The synthesized electrochromic polymer (ProDOT-Ph-ProDOT)ₙ has a molecular weight Mw of 98.9 kDa and a PDI of 1.94. The electrochromic polymer (ProDOT-Ph-ProDOT)ₙ is dispersed in chloroform with a concentration of 20 mg/ml. 0.1 mL resulting (ProDOT-Ph-ProDOT)ₙ solution is spin-coated onto a 20*30*0.7 mm ITO substrate at the speed of 1500 rpm for 30 seconds. The (ProDOT-Ph-ProDOT)ₙ thin film is tested in a three-electrode configuration as the working electrode, Ag/AgCl as the reference electrode, and Pt wire as the counter electrode. The (ProDOT-Ph-ProDOT)ₙ thin film show orange color at colored state, and pale blue color when oxidized at 1.2 V, as shown by the cyclic voltammogram and the thin film photos in FIG. 2. As shown in FIG. 3, The (ProDOT-Ph-ProDOT)ₙ thin film has a maximal absorbance peak at the wavelength around 480 nm when reduced (solid line), while very low absorbance at all wavelength lower than 1000 nm when oxidized (dash line). The example (ProDOT-Ph-ProDOT)ₙ thin film can maintain a stable switching kinetic with ˜60% optical contrast at 480 nm when switching between −0.2 V to 1.2 V, as shown in FIG. 4.

### Embodiment 4: The Reaction Unit Comprises ProDOT-Naphth-ProDOT-Cl

In some embodiments, the reaction unit comprises a trimer with three electron donor groups (ProDOT-Naphth-ProDOT-Cl):

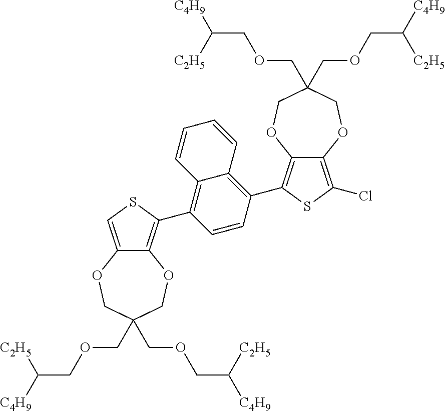

ProDOT-Naphth-ProDOT-Cl may be synthesized by the similar scheme as scheme 3 and then further adopts the similar scheme of acid-catalyzed cationic polymerization as scheme 2 to produce an electrochromic polymer block with a formula of

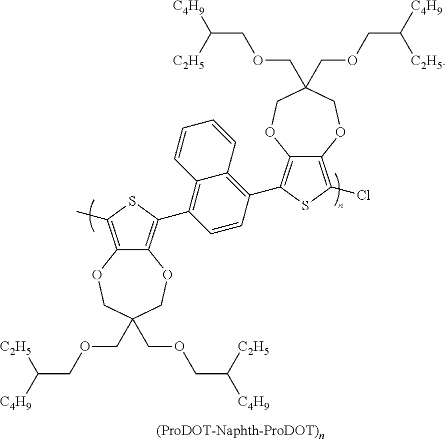

### Embodiment 5: The Reaction Unit Comprises ProDOT-Py-ProDOT-Cl

In some embodiments, the reaction unit comprises a trimer with three electron donor groups (ProDOT-Py-ProDOT-Cl):

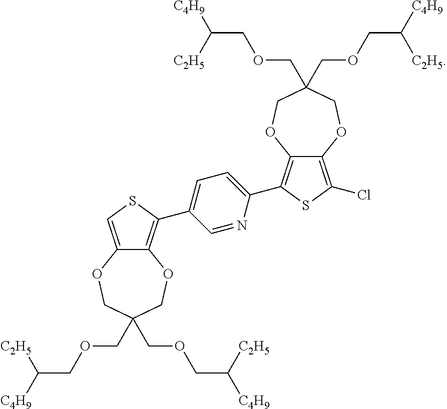

ProDOT-Py-ProDOT-Cl, for example, may be prepared by a two-step synthesis method. Scheme 4 illustrates a two-step synthesis method according to one example embodiment.

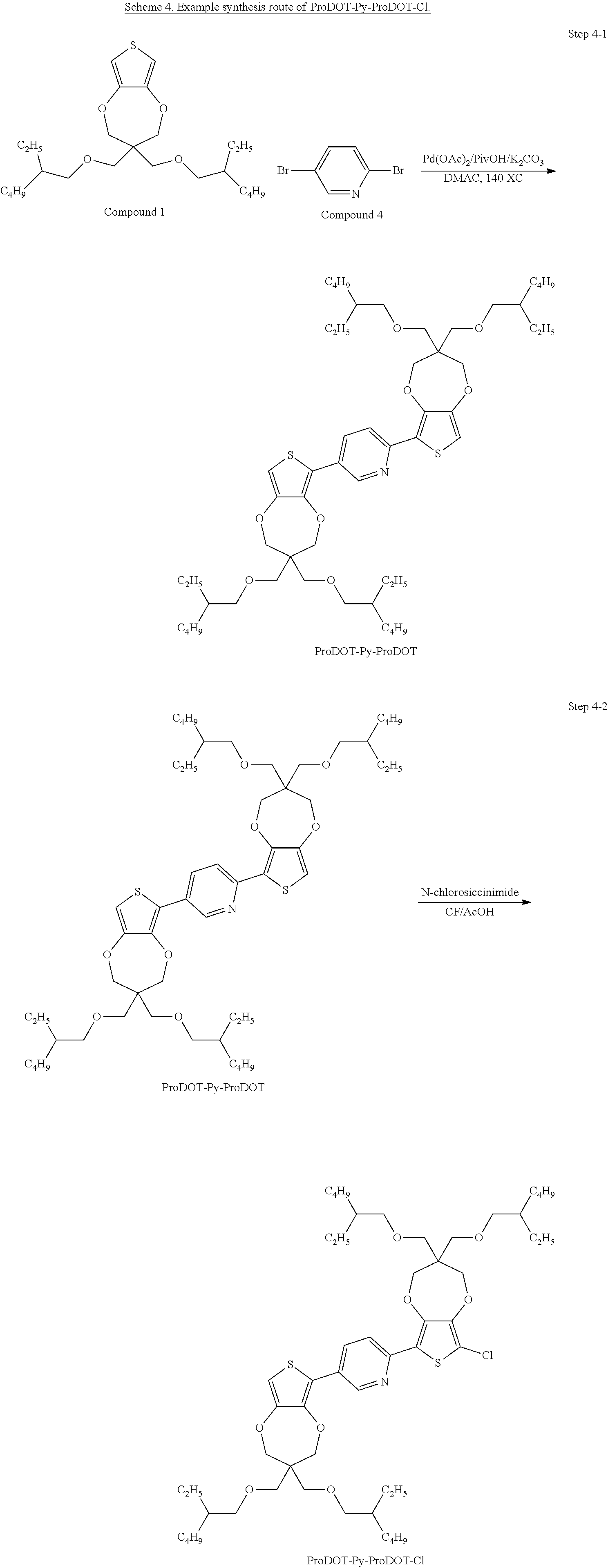

In example step 4-1, ProDOT-Py-ProDOT is synthesized by mixing compound 5 (12 eq.), compound 6 (1 eq.), Pd(OAc)₂ (8 mol %), pivalic acid (1.2 eq.), and K₂CO₃ (1.25 eq.) in a 50 mL round bottom flask. The vessel is sealed and purged three times with argon. Dimethylacetamide (5 mL) is added to the flask, and the reaction solution is heated to 140° C. Afterward, the reaction solution is quenched by the addition of EtOAc (20 ml) when all of the compound 6 derivatives are consumed, which is monitored by TLC (˜5 minutes). After returning to room temperature, the reaction mixture is poured into water (˜100 mL) and extracted with DCM (30 mL). The organics are washed with water (˜50 mL) and brine (˜25 ml). The organic phase is dried over MgSO₄, filtered, and concentrated under reduced pressure. The crude product is purified by silica column chromatography with 2:1 hexane:DCM as the eluent(˜52% yield).

In example step 4-2, to a stirred solution of ProDOT-Py-ProDOT (3.8 mmol) in a mixture CHCl₃/AcOH (20 mL/20 mL) at 0° C., a solution of N-chlorosuccinimide (3.6 mmol) in 5 mL of chloroform is added dropwise, and the reaction mixture is stirred at room temperature overnight. To the reaction mixture, water (20 mL) is added and the mixture is washed with ethyl acetate (3×20 mL), the organic fraction is dried over anhydrous sulfate magnesium, the solvent is removed under reduced pressure, and the resulting material (˜69% yield) is purified by chromatography column on silica gel.

By the similar scheme of acid-catalyzed cationic polymerization as scheme 2, ProDOT-Py-ProDOT-Cl can be used to produce an electrochromic polymer block with a formula of

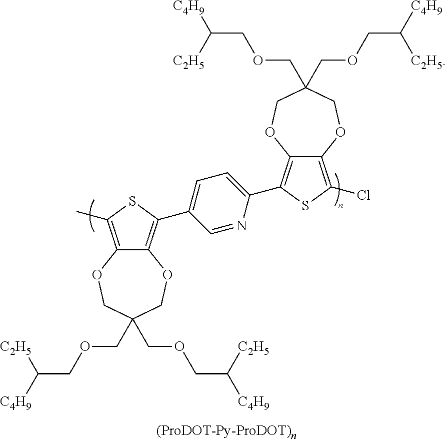

### Embodiment 6: The Reaction Unit Comprises ProDOT-BTD-ProDOT-Cl

In some embodiments, the reaction unit comprises a trimer with one electron acceptor group between two electron donor groups, ProDOT-BTD-ProDOT-Cl:

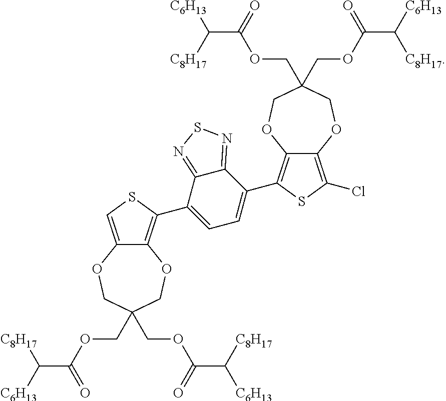

ProDOT-BTD-ProDOT-Cl may be synthesized by the similar scheme as scheme 4 and then further adopts the similar scheme of acid-catalyzed cationic polymerization as scheme 2 to produce an electrochromic polymer block with a formula of

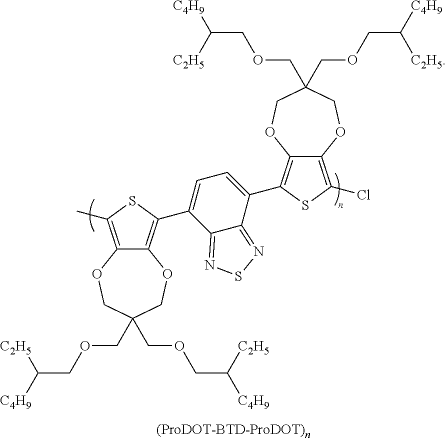

### Embodiment 7: The Reaction Unit Comprises ProDOT-TPD-ProDOT-Cl

In some embodiments, the reaction unit comprises a trimer with one electron acceptor group between two electron donor groups, ProDOT-TPD-ProDOT-Cl:

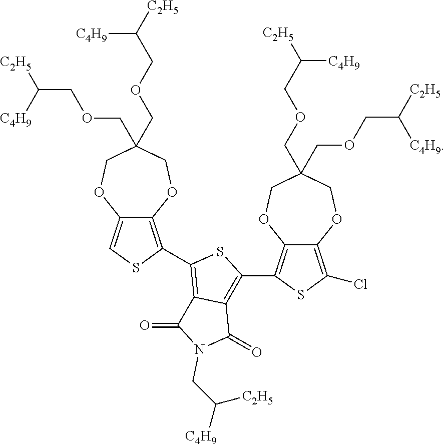

ProDOT-TPD-ProDOT-Cl may be synthesized by the similar scheme as scheme 4 and then further adopts the similar scheme of acid-catalyzed cationic polymerization as scheme 2 to produce an electrochromic polymer block with a formula of

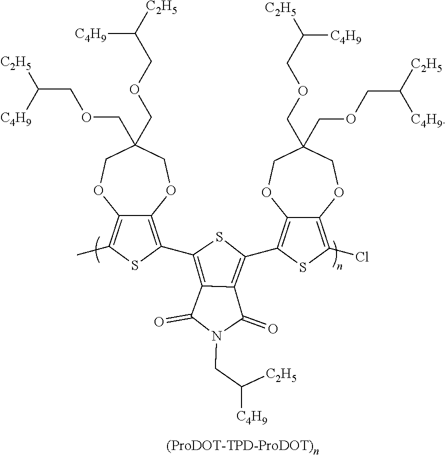

### Embodiment 8: The Reaction Units Comprise ProDOT-Cl and EDOT-Cl Sequentially

The polymer block is synthesized by an acid-catalyzed cationic polymerization with ProDOT-Cl and EDOT-Cl as the reaction unit sequentially as illustrated in scheme 5, according to one example embodiment.

To a solution of ProDOT-Cl (0.33 mmol) in anhydrous o-DCB (2 mL) at 120° C., SnCl₄ (5%, 0.03 mMol) in anhydrous o-DCB (0.2 mL) is added and the resulting product is stirred at 120° C. After 12 h, EDOT-Cl. (0.33 mmol) in anhydrous o-DCB (2 mL) is added to the mixture and stirred at 120° C. for another 24 hours. The reaction mixture is poured into MeOH (200 mL), and few drops (4-10) of hydrazine hydrate are added to neutralize/dedope the polymer. The mixture is stirred for 1-3 h to allow the precipitation of the product. The solid is filtered and washed with MeOH (200 mL) and hexanes (200 mL) and dried under vacuum (˜86% yield).

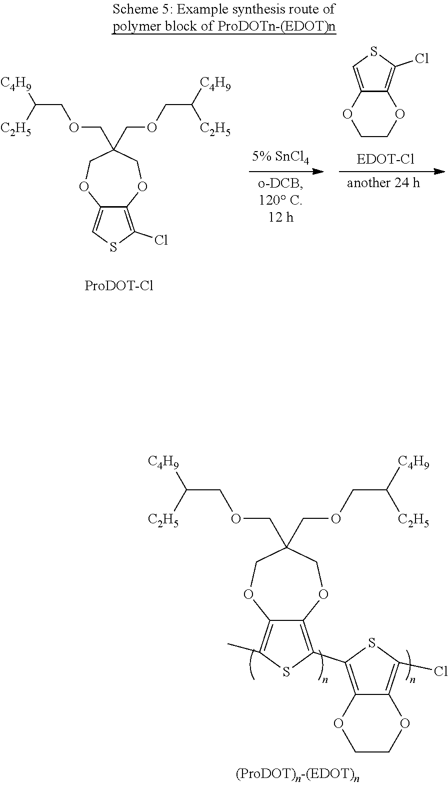

### Embodiment 9: The Reaction Units Comprise ProDOT-Cl and EDOT-Cl Sequentially

The polymer block is synthesized by an acid-catalyzed cationic polymerization with ProDOT₂-Cl and ProDOT-Ph-ProDOT-Cl as the reaction units sequentially as illustrated in scheme 6, according to one example embodiment.

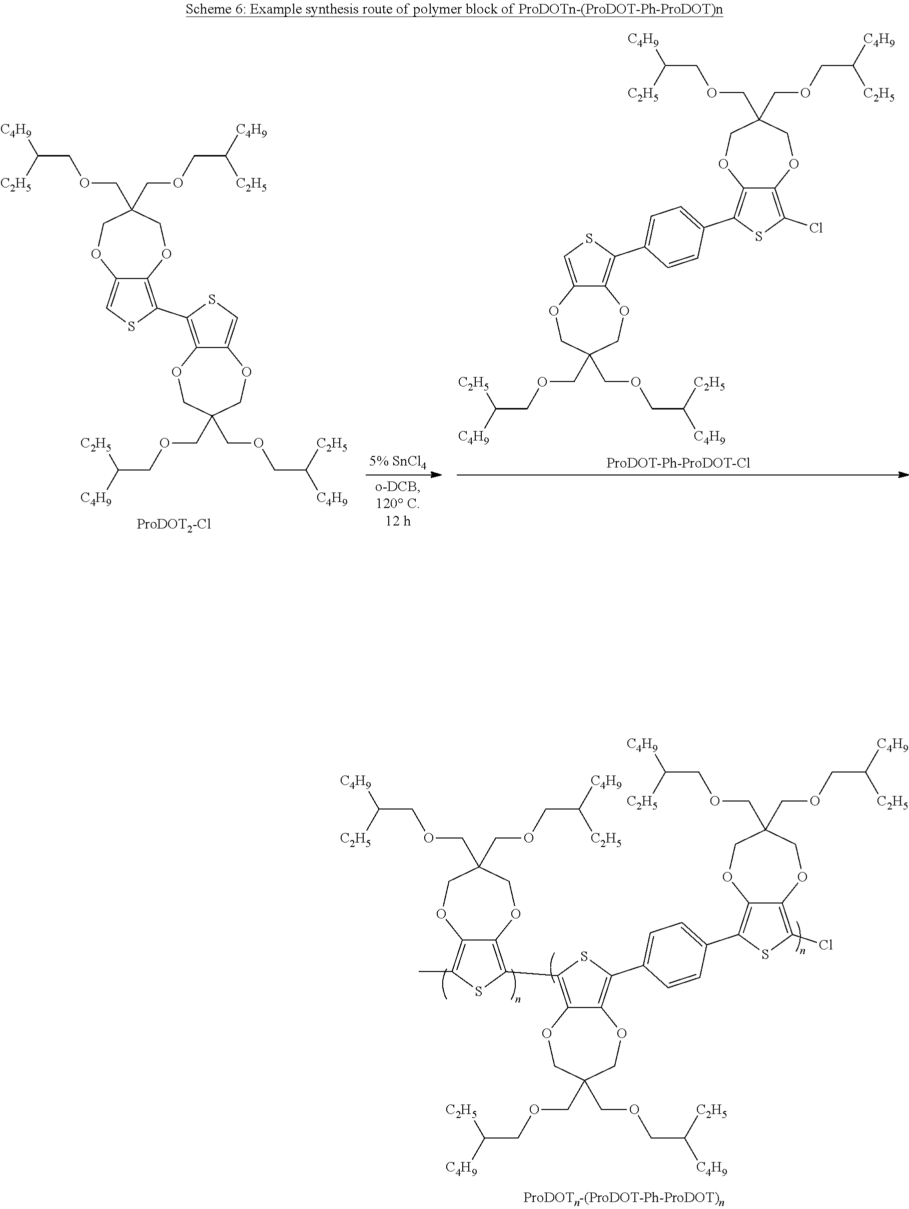

To a solution of ProDOT₂-Cl (0.33 mmol) in anhydrous o-DCB (2 mL) at 120° C., SnCl₄ ((5%, 8.6 mg, 3.8 μL, 0.03 mMol)) in anhydrous o-DCB (0.2 mL) is added and the resulting product is stirred at 120° C. After 12 h, ProDOT-TPD-ProDOT-Cl (0.33 mmol) in anhydrous o-DCB (2 mL) is added to the mixture and stirred at 120° C. for another 24 hours. The reaction mixture is poured into MeOH (200 mL), and a few drops (4-10) of hydrazine hydrate are added to neutralize/dedope the polymer. The mixture is stirred for 1-3 h to allow the precipitation of the product. The solid is filtered and washed with MeOH (200 mL) and hexanes (200 mL) and dried under vacuum (˜86% yield).

### Embodiment 10: The Reaction Unit Comprise ProDOT-pH-ProDOT-Cl

The polymer block is synthesized by an acid-catalyzed cationic polymerization with commercially available polymer P3HT-Br and ProDOT-Ph-ProDOT-Cl as the reaction unit as illustrated in scheme 7, according to one example embodiment.

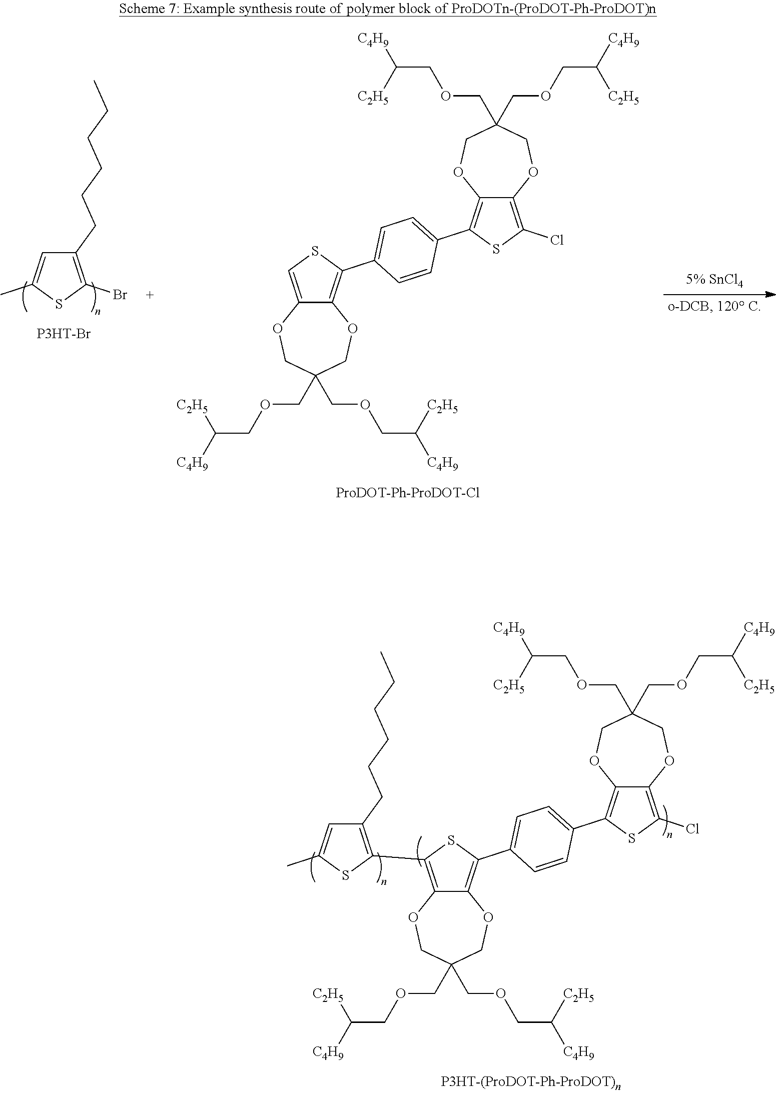

To a solution of P3HT-Br (0.033 mmol) in anhydrous o-DCB (2 mL) at 120° C., SnCl₄ ((5%, 8.6 mg, 3.8 μL, 0.03 mMol)) in anhydrous o-DCB (0.2 mL) is added and the resulting product is stirred at 120° C. After 2 h, ProDOT-TPD-ProDOT-Cl (0.33 mmol) in anhydrous o-DCB (2 mL) is added to the mixture and stirred at 120° C. for another 24 hours. The reaction mixture is poured into MeOH (200 mL), and a few drops (4-10) of hydrazine hydrate are added to neutralize/dedope the polymer. The mixture is stirred for 1-3 h to allow the precipitation of the product. The solid is filtered and washed with MeOH (200 mL) and hexanes (200 mL) and dried under vacuum (˜86% yield).

The adopted acid-catalyzed cationic polymerization can introduce more modular blocks with various properties to the disclosed electrochromic polymers and endow them with various properties, such as low bandgap to produce more abundant colors, low polydispersity index (PDI) and large molecular weight for polymers with more heterogeneity and better electrochromic performance. The acid-catalyzed cationic polymerization comprises Lewis-acid catalyzed polymerization and Brønsted-acid promoted cationic polymerization. In some embodiments, example Lewis-acid catalysts comprise BF₃, AlCl₃, FeCl₃, TiCl₄, TfOH, AuCl₃, SnCl₄, SbCl₅ etc. In some embodiments, example Brønsted-acid catalysts comprise arachidonic acid, trifluoroacetic acid, and methanesulfonic acid.

During the acid-catalyzed cationic polymerization, selectively initiated species end-capped with appropriate reactive functional groups can grow up, in which the propagation proceeds in a unidirectional way. It leads to diminishing the randomness and eventually produces an electrochromic polymer with great molecular weights and low PDI values. Benefit from the acid-catalyzed cationic polymerization, the disclosed electrochromic polymer has low PDI values. In some embodiments, the disclosed electrochromic polymer has a PDI value lower than 3. In some embodiments, the disclosed electrochromic polymer has a PDI value lower than 2.5 or lower than 2.2 or lower than 2 or lower than 1.7 or lower than 1.5.

The disclosed electrochromic polymer shows reversible color or optical transmittance changes with an optical contrast when a voltage is applied. In some embodiments, the working voltage of the disclosed electrochromic polymer is higher than 2V. In some embodiments, the working voltage of the disclosed electrochromic polymer is within 2V or within 1.8 V or within 1.6 V or within 1 V.

The optical contrast of the disclosed electrochromic polymer is calculated by the transmittance differences at its maximum absorption wavelengths between the colored state and the bleached state of the disclosed electrochromic polymers. In some embodiments, the optical contrast of the disclosed electrochromic polymer is higher than 20% at the maximum absorption. In some embodiments, the optical contrast of the disclosed electrochromic polymer is higher than 30% or 40%, or 50% or 60% at the maximum absorption.

The disclosure also directs to a device incorporating the disclosed electrochromic polymer.

What is claimed is:

1. A method for forming an electrochromic polymer block, the method comprising:
forming each of reaction units by reacting two or more electron-donor groups, wherein each of the reaction units includes (i) a first backbone formed by the two or more electron-donor groups and (ii) at least one reactive functional group connected to each end of the first backbone; and
forming the electrochromic polymer block by reacting at least two of the reaction units with acid-catalyzed cationic polymerization, wherein the electrochromic polymer block includes a second backbone formed by two or more of the first backbones.

2. The method of claim 1, wherein the two or more electron-donor groups are the same.

3. The method of claim 1, wherein at least two of the two or more electron-donor groups are different.

4. The method of claim 1, wherein at least one of the reaction units is formed by reacting the two or more electron-donor groups with an electron-acceptor group such that the electron-acceptor group is sandwiched by two of the two or more electron-donor groups in the first backbone.

5. The method of claim 1, wherein at least one of the reaction units is formed by reacting three different electron-donor groups such that the first backbone is formed by the three different electron-donor groups.

6. The method of claim 1, wherein the reactive functional groups comprise one of H, Br, Cl, or I.

7. The method of claim 1, wherein the acid-catalyzed cationic polymerization comprises Lewis-acid catalyzed cationic polymerization or Brønsted-acid catalyzed cationic polymerization.

8. The method of claim 1, wherein the two or more electron-donor groups comprise thiophene, EDOT, pyrrole, carbazole, triphenylamine, or benzos.

9. The method of claim 1, wherein the electron-acceptor group comprises benzothiadiazole (BT), thiazole, pyridine, fluorinated benzene (FB), diketopyrrolopyrrole (DPP), isoindigo (ID), thieno[3,4-c]pyrrole-4,6-dione (TPD) and quinoxalineimide.

10. A method for forming an electrochromic polymer comprising reacting the electrochromic polymer block of claim 1 with at least one reaction unit by acid-catalyzed cationic polymerization.

11. A method for forming an electrochromic polymer, the method comprising:
forming each of reaction units by reacting two or more electron-donor groups, wherein each of the reaction units includes (i) a first backbone formed by the two or more electron-donor groups and (ii) at least one reactive functional group connected to each end of the first backbone; and
forming the electrochromic polymer by reacting an electrochromic polymer block with at least one of the reaction units by acid-catalyzed cationic polymerization,
wherein the electrochromic polymer block has at least one electron donor group end capped with at least one reactive functional group.

12. A method for forming an electrochromic device, the method comprising:
forming each of reaction units by reacting two or more electron-donor groups, wherein each of the reaction units includes (i) a first backbone formed by the two or more electron-donor groups and (ii) at least one reactive functional groups connected to each end of the first backbone;
forming the electrochromic polymer block by reacting at least two of the reaction units with acid-catalyzed cationic polymerization, wherein the electrochromic polymer block includes a second backbone formed by two or more of the first backbones; and
incorporating the electrochromic polymer block into a cell coupled to two electrodes.

13. The method of claim 12, wherein the two or more electron-donor groups are the same.

14. The method of claim 12, wherein at least two of the two or more electron-donor groups are different.

15. The method of claim 12, wherein at least one of the reaction units is formed by reacting the two or more electron-donor groups with an electron-acceptor group such that the electron-acceptor group is sandwiched by two of the two or more electron-donor groups in the first backbone.

16. The method of claim 12, wherein at least one of the reaction units is formed by reacting three different electron-donor groups such that the first backbone is formed by the three different electron-donor groups.

17. The method of claim 12, wherein the reactive functional groups comprise one of H, Br, Cl, or I.

18. The method of claim 12, wherein the acid-catalyzed cationic polymerization comprises Lewis-acid catalyzed cationic polymerization or Brønsted-acid catalyzed cationic polymerization.

19. The method of claim 12, wherein the two or more electron-donor groups comprise thiophene, EDOT, pyrrole, carbazole, triphenylamine, or benzos.

20. The method of claim 12, wherein the electron-acceptor group comprises benzothiadiazole (BT), thiazole, pyridine, fluorinated benzene (FB), diketopyrrolopyrrole (DPP), isoindigo (ID), thieno[3,4-c]pyrrole-4,6-dione (TPD) and quinoxalineimide.
